(19) United States
(12) Patent Application Publication
(10) Pub. No.: US 2010/0204812 A1
(43) Pub. Date: Aug. 12, 2010

(54) DIGITAL AUDIO SIGNAL INTERPOLATION APPARATUS AND DIGITAL AUDIO SIGNAL INTERPOLATION METHOD

(75) Inventor: Koshi SETO, Kanagawa (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/701,173

(22) Filed: Feb. 5, 2010

(30) Foreign Application Priority Data
Feb. 6, 2009 (JP) 2009-026600

(51) Int. Cl. G06F 17/00

(52) U.S. Cl. 700/94

(57) ABSTRACT

The apparatus or the method of this invention selects an interpolation value candidate region for an uncorrectable point, equally divides the interpolation value candidate region into a plurality of divided regions, causes representative values of the divided regions to be added to and passed through a high-pass filter that reproduces a state up to a point immediately preceding the uncorrectable point, selects a divided region in which a value is lowest and further divides the selected region equally into a plurality of divided small regions, causes representative values of the divided small regions to be added to and passed through the high-pass filter that reproduces a state up to the point immediately preceding the uncorrectable point, and takes a representative value of a divided small region in which a value is lowest as the interpolation value of the uncorrectable point.

### CROSS REFERENCE TO RELATED APPLICATION

This application is based upon and claims the benefit of priority from the prior Japanese Patent Application 2009-26600 filed in Japan on Feb. 6, 2009; the entire contents of which are incorporated herein by reference.

### BACKGROUND OF THE INVENTION

1. Field of the Invention

The present invention relates to an interpolation apparatus and an interpolation method for digital audio signals, and more particularly to an interpolation apparatus and an interpolation method for digital audio signals that interpolates a signal value of an uncorrectable sampling point using a signal value of a preceding point for a playback device that plays back a CD-DA or a device that plays back an MP3 file or the like from a CD-ROM.

2. Description of the Related Art

In digital audio signal playback equipment such as CDs (compact disks), the generation of errors is unavoidable during a process that records digital audio as a sound source or in a process of playing back the digital audio. It is therefore normal to devise a countermeasure for errors using error-correcting code. However, when an error that exceeds the correcting capability of an error-correcting code occurs, correction of the error is not possible.

Conventionally, in such a case, the influence of errors is decreased by performing interpolation with respect to an uncorrectable sampling point (hereunder, referred to simply as “point”) using a correct point that is temporally close to the uncorrectable point. Examples of known digital audio signal interpolation apparatuses of this kind include an apparatus disclosed in Japanese Patent No. 3572769. According to the apparatus disclosed in Japanese Patent No. 3572769, a product-sum operation is performed with respect to an uncorrectable point (hereunder, referred to as “target point”) as an interpolation target and correct points before and after (several points before and after, respectively) the interpolation target using one or more kinds of coefficient tables that are previously stored in a memory, and interpolation is performed with respect to a value of the target point based on the result.

However, according to the apparatus disclosed in Japanese Patent No. 3572769, there is a problem that when a plurality of the target points exist, the coefficient tables used for interpolation increase in number and hence the calculation volume increases and the processing becomes complex. Further, although an IIR-type filter is used for the product-sum operation, an interpolation effect is low with a simple IIR-type filter and an interpolated value of a target point is a value that is comparatively far from the true value. Hence, there is a problem that when the target point for which an interpolated value is used and the points before and after the target point are played back, a “click” noise that is distracting in ear (hereunder, referred to as “click noise”) remains (a click noise reducing effect is low).

A device is also known that uses a mean value of correct points before and after a target point as the value of the target point. However, in a case where a plurality of target points occur in succession or where a target point is a peak point, the interpolation effect is low and the interpolated value is a value that differs significantly from the true value. A device that has been proposed (Japanese Patent Application Laid-Open Publication No. 9-17133) to improve this situation interpolates a value of a target point using a rate of increase of preceding and succeeding correct points.

The device disclosed in Japanese Patent Application Laid-Open Publication No. 9-17133 has the advantage that the device can also be applied to a case in which a plurality of target points occur in succession. However, because the device fixes a processing range used for correction (number of preceding and succeeding points as the calculation object for the rate of increase) and incorporates the range into a buffer, and then makes a waveform to perform interpolation of a target point, there is a problem that the processing for interpolation such as a start judgment is complex.

### BRIEF SUMMARY OF THE INVENTION

A digital audio signal interpolation apparatus according to one aspect of the present invention is configured to interpolate an uncorrectable point in a digital audio signal extracted from a CD or the like, wherein the apparatus selects an interpolation value candidate region of the uncorrectable point; equally divides the interpolation value candidate region into a plurality of divided regions; causes representative values of the divided regions to be added to and passed through a high-pass filter that reproduces a state up to a point immediately preceding the uncorrectable point; selects one of the divided regions in which a value is lowest, and further divides the selected region equally into a plurality of divided small regions; causes representative values of the divided small regions to be added to and passed through the high-pass filter that reproduces a state up to a point immediately preceding the uncorrectable point; and takes the representative value of one of the divided small regions in which a value is lowest as an interpolation value of the uncorrectable point.

### BRIEF DESCRIPTION OF THE DRAWINGS

FIG. 1 is a schematic block diagram that explains an example of the configuration of a digital audio signal interpolation apparatus according to an embodiment of the present invention;

FIG. 2 is a flowchart that explains a flow of a series of operations that interpolate an uncorrectable point;

FIG. 3 is a flowchart that explains a flow of a series of interpolation operations in a case in which an uncorrectable point is a single point;

FIG. 4 is a flowchart that explains a flow of a series of interpolation operations in a case in which there are two successive uncorrectable points;

FIG. 5A to FIG. 5C are schematic diagrams for explaining interpolation methods;

FIG. 6A to FIG. 6C are schematic views for explaining an interpolation method in a sample interpolation process P₁;

FIG. 7A to FIG. 7D are schematic views for explaining an interpolation method in a sample interpolation process P₂; and

FIG. 8 is a simple program that shows a flow of a series of operations that interpolate an uncorrectable point expressed in C language.

### DETAILED DESCRIPTION OF THE INVENTION

An embodiment of the present invention is described hereunder with reference to the drawings.

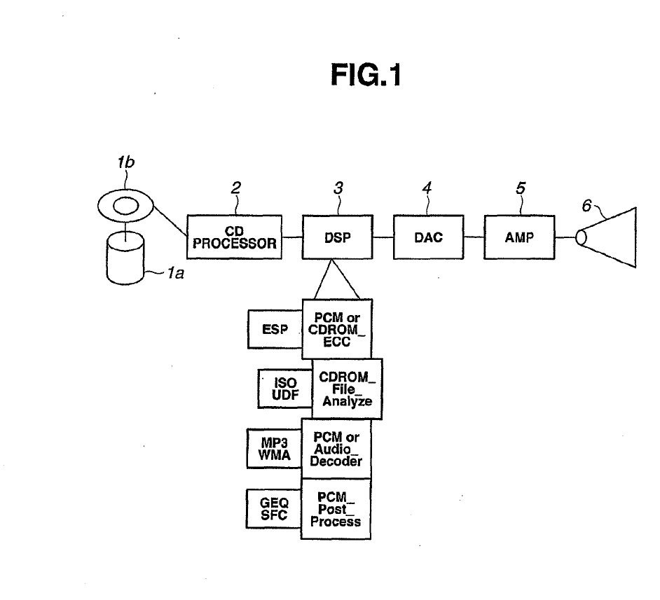

First, the configuration of a digital audio signal interpolation apparatus according to the present embodiment will be described referring to FIG. 1. FIG. 1 is a schematic block diagram that explains an example of the configuration of a digital audio signal interpolation apparatus according to an embodiment of the present invention.

As shown in FIG. 1, a digital audio signal interpolation apparatus according to the present embodiment includes a CD 1b on which is recorded a digital audio signal such as a CD-DA, a CD decoder 1a, a CD processor 2 that extracts a digital audio signal from the CD 1b, a DSP 3 that analyzes and processes a digital audio signal that is extracted, a DAC 4 that converts a digital audio signal to an analog audio signal, an AMP 5 that amplifies an audio signal that has undergone conversion to analog, and a speaker 6 that outputs an audio signal.

The CD-DA specifications are standardized as a sampling frequency of 44.1 kHz, a quantifying bit depth of 16 bits, and two channels (L, R). Accordingly, a digital audio signal extracted by the CD processor 2 is input to the DSP 3 as three kinds of signals, namely, a clock signal for channels (L/R), a base clock signal for the 44.1 kHz sampling frequency, and an audio data signal.

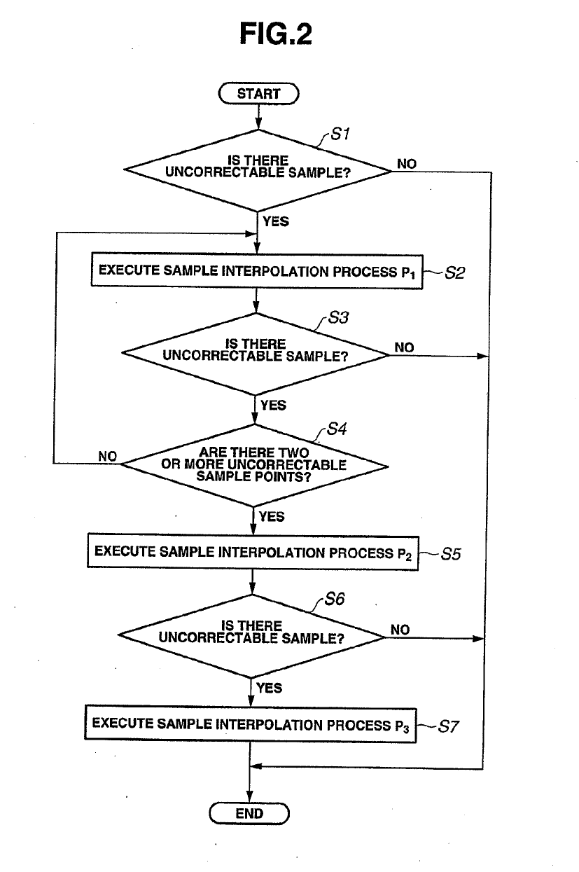

Next, procedures for performing interpolation at the DSP 3 in a case in which an uncorrectable point is detected from an input digital audio signal are described using FIG. 2. FIG. 2 is a flowchart that explains a flow of a series of operations that interpolate an uncorrectable point.

As shown in FIG. 2, in S1, the DSP 3 identifies whether or not there is a point for which error correction is not possible in the input digital audio signal. When there is no point for which error correction is not possible, the DSP 3 determines that interpolation is not necessary and ends the interpolation processing.

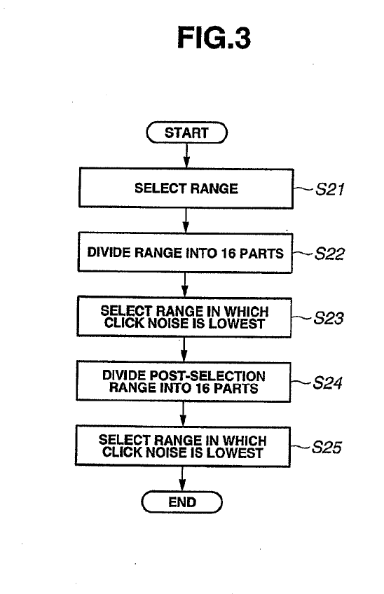

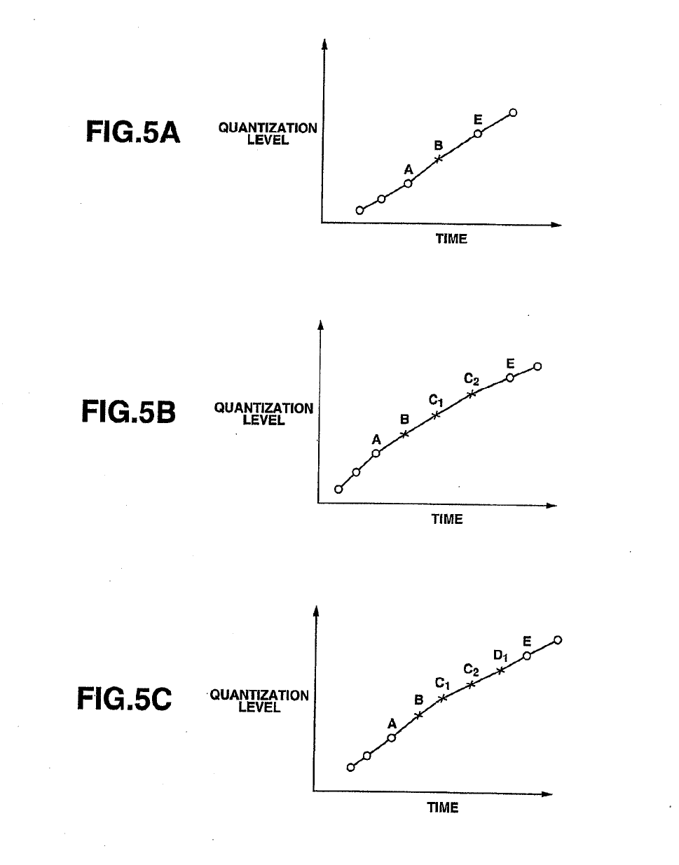

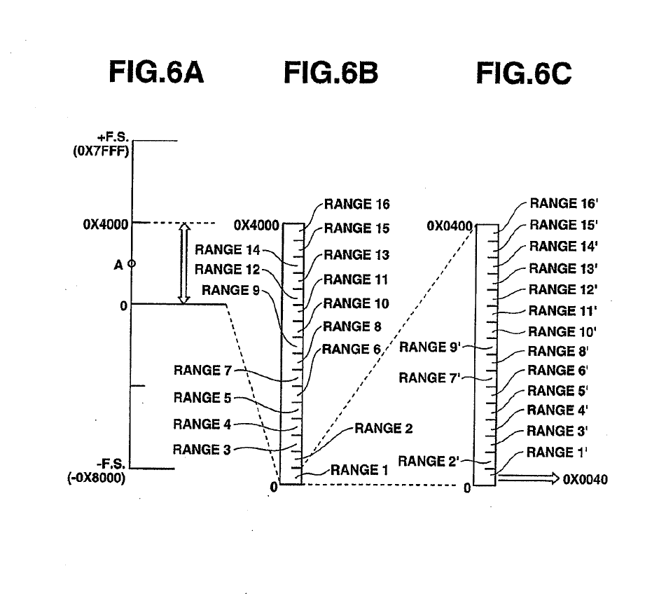

In contrast, in S1, when the DSP 3 identifies that there is an uncorrectable point, the DSP 3 executes a sample interpolation process P₁ (S2). The specific procedures of the sample interpolation process P₁ will now be described using FIG. 3, FIG. 5A to FIG. 5C, and FIG. 6A to FIG. 6C. FIG. 3 is a flowchart that explains a flow of a series of interpolation operations in a case in which an uncorrectable point is a single point. FIG. 5 includes schematic diagrams for explaining an interpolation method, in which FIG. 5A is a schematic diagram for a case where there is one uncorrectable point, FIG. 5B is a schematic diagram for a case where there are three successive uncorrectable points, and FIG. 5C is a schematic diagram for a case where there are four successive uncorrectable points. FIG. 6A to FIG. 6C are schematic views for explaining an interpolation method in the sample interpolation process P₁.

As shown in FIG. 3, when the sample interpolation process P₁ is started, first, the DSP 3 selects a range as a target for calculation of an interpolation value of the uncorrectable point (S21). As the calculation target range for an interpolation value, for example, it is possible to use a range that is defined at a width of ¼ of the upper and lower full scale that takes as a center a value of a correct point that immediately precedes the uncorrectable point. Further, for example, a range in which there is from one to two points that immediately follow an uncorrectable point or a range of double the amount of the aforementioned range can also be used. The aforementioned two methods of selecting ranges are merely examples, and a range may be selected by a method other than those described above.

Here, an example will be explained in which a calculation target range for an interpolation value is selected using the former method among the above described selection methods for a case where, as shown in FIG. 5A, for example, a point B is an uncorrectable point and the immediately preceding point A and the immediately succeeding point E are correct values. Since the quantifying bit depth is 16 bits, a full scale that takes 0 as the center is from −0x7 FFF to 0x7 FFF. For example, when the value of point A is 0x2000, a range that is defined at a width of ¼ of the upper and lower full scale that takes 0x2000 as the center is a range from 0 to 0x4000 as shown in FIG. 6A. That is, the calculation target range for the interpolation value selected at S21 is a range from 0 to 0x4000.

Next, the selected calculation target range for the interpolation value is divided into 16 parts (S22; see FIG. 6B).

Subsequently, a representative point (value) is extracted from each of the 16 ranges into which the calculation target range has been divided, and the extracted representative points are employed as point B interpolation candidates (values) (S23). For each range, the point B interpolation candidate is passed through a second-order HPF (high-pass filter) with a cut-off frequency of 10 kHz. At the HPF, an internal state up to the point A that is the correct point immediately preceding the point B which requires correcting is repeated and reproduced. The point B candidates are added to the reproduced state, i.e. the correct state up to point A, and the results are output. Further, narrowing down of ranges is performed to obtain a range in which an output value from the HPF is lowest to serve as a calculation target range for the interpolation value in the next step.

Narrowing down of ranges to obtain the interpolation value calculation range in S23 is performed by utilizing the property that a click noise becomes lower in accordance with the proximity of an interpolation value to the true value. Since a click noise is present in a high frequency region, the click noise is detected by adding point B interpolation candidates to a correct state up to point A and passing the result through a HPF that cuts off a region equal to or below 10 kHz and allows only a high frequency region to pass through. In this case, for example, it is assumed that a range from 0 to 0x0400 is selected as a range in which the click noise is lowest.

Next, the interpolation value calculation target range selected in S23 is further divided into 16 parts (S24; see FIG. 6C).

Finally, a range in which the click noise is lowest is selected from the 16 ranges obtained by dividing the selected range in S24, and the representative value of the selected range is employed as the interpolation value of point B. For example, when the range from 0 to 0x0040 is selected as the range in which the click noise is lowest, 0x0040 as the representative value of the aforementioned range is taken as the interpolation value of point B. In the case of the above described example, by narrowing down the interpolation value calculation target range in S21, S23, and S25, an accuracy of 2 bits+4 bits+4 bits=10 bits is obtained for the interpolation value of point B. It is also possible to obtain an accuracy of more than 10 bits by appropriately performing selection of the target range in S21.

When the sample interpolation process P₁ in S2 is completed, the DSP 3 determines whether or not there is another sample for which error correction is not possible (S3). When there is no point for which error correction is not possible, that is, when interpolation has been completed for all points with uncorrectable errors by executing S2, the DSP 3 ends the interpolation processing.

On the other hand, in S3, if the DSP 3 determines that there is an uncorrectable point, the DSP 3 then determines whether or not two or more consecutive uncorrectable points exist (S4). When two or more consecutive uncorrectable points do not exist, the DSP 3 determines that the uncorrectable point is only a single point, and therefore returns to S2 to perform interpolation processing for the point in question (executes the sample interpolation process P₁).

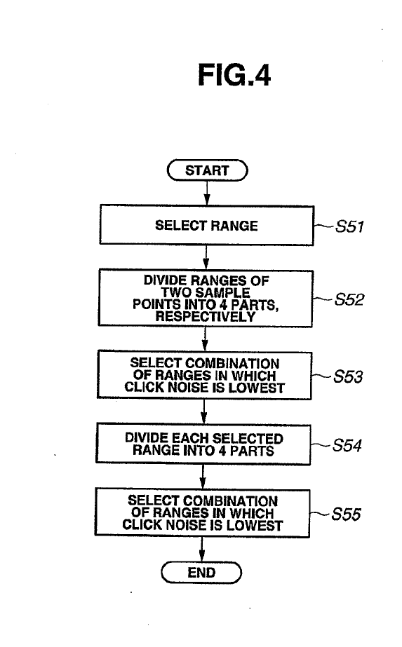

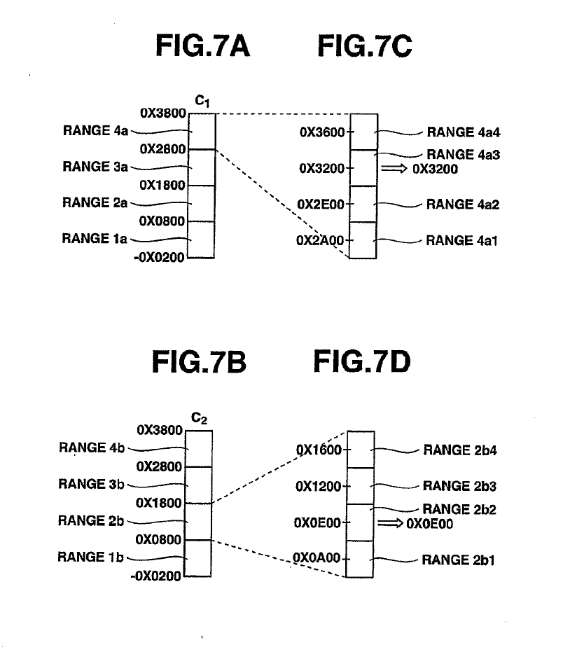

On the other hand, in S4, if the DSP 3 determines that two or more consecutive uncorrectable points exist, the DSP 3 executes a sample interpolation process P₂ (S5). The specific procedures of the sample interpolation process P₂ in this case will now be described using FIG. 4, FIG. 5A to FIG. 5C, and FIG. 7A to FIG. 7D. FIG. 4 is a flowchart that explains a flow of a series of interpolation operations in a case in which there are two consecutive uncorrectable samples. FIG. 7A to FIG. 7D are schematic views for explaining an interpolation method in the sample interpolation process P₂.

As shown in FIG. 4, when the sample interpolation process P₂ is started, first, the DSP 3 selects a range as a target for calculation of an interpolation value of the uncorrectable points (S51). The method of selecting the interpolation value calculation target range is the same as in S21 of the sample interpolation process P₁.

Here, as one example, a case is described in which, as shown in FIG. 5B, points C₁ and C₂ are uncorrectable points, point B is a point for which an interpolation value is calculated by the sample interpolation process P₁, and point A and point E are correct values.

In this connection, similarly to the above description regarding S21, it is assumed that for the calculation target range for the interpolation values, a range selected is defined at a width of ¼ of the upper and lower full scale that takes as a center a value of the point immediately preceding the uncorrectable points, that is, the value of the point B. For example, when the interpolation value of point B is 0x1800, a range that is defined at a width of ¼ of the upper and lower full scale when taking 0x1800 as the center is a range from −0x0200 to 0x3800. More specifically, the calculation target range for the interpolation value selected in S51 is the range from −0x0200 to 0x3800.

Next, the selected calculation target range for the interpolation value is divided into four parts with respect to the point C₁ and the point C₂, respectively (S52; see FIGS. 7A and 7B).

Subsequently, the DSP 3 extracts representative points (values) from each of the four ranges obtained by the division in S52 with respect to the point C₁ and point C₂, respectively, and takes the extracted representative points to be point C₁ interpolation candidates (values) and point C₂ interpolation candidates (values) (S53). Next, with respect to all combinations of the four ranges relating to point C₁ and the four ranges relating to point C₂, the DSP 3 passes two points consisting of a point C1 interpolation candidate and a point C2 interpolation candidate through a second-order HPF with a cut-off frequency of 10 kHz. At the HPF, the past internal state up to the corrected point B is repeated, and the point C1 interpolation candidate and the point C2 interpolation candidate are added thereto and results are output. Further, narrowing down of the ranges is performed by taking a range in which an output value from the HPF is lowest as the next interpolation value calculation target range.

In this connection, there is a total of 16 combinations with respect to the entire number of combinations of the four ranges relating to point C₁ and the four ranges relating to point C₂. A combination with the lowest value is obtained by, with respect to each combination, passing interpolation candidates (values) of selected ranges through the HPF and adding the interpolation candidates (values) to the past correct state (past state including the corrected point B).

In this case, as one example, it is assumed that an output value from the HPF is lowest for a combination of a range from 0x2800 to 0x3800 (point C₁) and a range from 0x0800 to 0x1800 (point C₂), and this combination is selected as the next interpolation value calculation target range.

Next, the interpolation value calculation target range selected in S53 is further divided into four parts (S54; see FIG. 7C and FIG. 7D).

Finally, similarly to S53, ranges in which a click noise is lowest are selected from all combinations of the four ranges relating to the point C₁ and the four ranges relating to the point C₂, and the representative values of these ranges are taken as the interpolation values of point C₁ and point C₂ (S55). For example, when a combination of a range from 0x3000 to 0x3400 (point C₁) and a range from 0x0C00 to 0x1000 (point C₂) is selected as ranges in which the click noise is lowest, as representative values of the respective ranges, 0x3200 is taken as the interpolation value of the point C₁ and 0x0E00 is taken as the interpolation value of the point C₂ (see FIG. 7C and FIG. 7D).

Upon completing the sample interpolation process P₂ at S5, the DSP 3 determines whether or not there are other samples for which error correction is not possible (S6). When there are no points for which error correction is not possible, that is, when interpolation has been completed for all points for which error correction is not possible, the DSP 3 ends the interpolation processing.

On the other hand, in S6, if the DSP 3 determines that there is another uncorrectable point, the DSP 3 executes a sample interpolation process P₃ (S7). When an uncorrectable point exists even after executing the sample interpolation process P₁ of S2 and the sample interpolation process P₂ of S5, it indicates that there are four or more successive uncorrectable points.

For example, as shown in FIG. 5C, this corresponds to a case in which point A is a point with a correct value, point B is a point for which an interpolation value is calculated by the sample interpolation process P₁, points C₁ and C₂ are points for which interpolation values are calculated by the sample interpolation process P₂, a point D₁ that follows the point C₂ is an uncorrectable point, and a point E is a correct value.

In the sample interpolation process P₃, the value of D₁ is generated by calculating a non-constant rate of increase/decrease based on the values of points B, C₁, and C₂ that are already interpolated. When five or more uncorrectable points exist in succession, values are consecutively generated in the manner D₂, D₃, . . . Dₙ. At this time, the values are generated such that the value of Dₙ is towards the zero direction, and not towards the upper or lower full scale side. In this connection, in a case in which the value of Dₙ reaches zero, the interpolation value of an uncorrectable point thereafter is assumed to be zero.

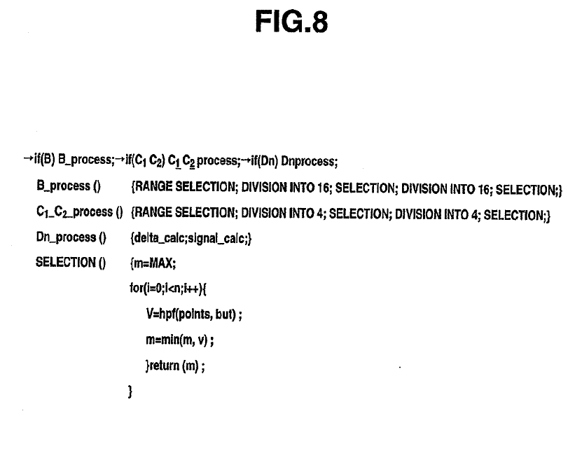

In S7, when the interpolation of all uncorrectable points is completed, the DSP 3 ends the interpolation processing shown in FIG. 2. FIG. 8 illustrates a program in which the series of procedures shown in FIG. 2, FIG. 3, and FIG. 4 are simply expressed by C language.

Thus, according to the embodiment of the present invention, a selection range of an interpolation value is narrowed down by repeating a series of procedures including extracting and dividing a range of interpolation candidates for an uncorrectable point, adding a representative value of each of the divided regions to a correct state before the relevant point and passing the result through a HPF, and selecting a range in which the value is lowest. It is therefore possible to obtain an accuracy of 10 bits or more with simple processing in which calculation volume is comparatively small, and to reduce to a minimum an error with respect to a true value. Further, a method of calculating an interpolation value is changed with respect to a case in which there are up to three consecutive uncorrectable points and a case in which the number of consecutive uncorrectable points exceeds three points. When the number of consecutive uncorrectable points exceeds three points, interpolation values for a fourth and subsequent point are generated by calculating a non-constant rate of increase/decrease that approaches zero using interpolation values calculated up to that time. Hence, interpolation values can be obtained with simpler processing.

The present invention is not limited to the above described embodiment, and various modifications and variations may be effected without departing from the spirit and scope of the invention.

For example, in the above described embodiment, when two consecutive uncorrectable points occur, interpolation values are determined by repeating the sample interpolation process P₁ two times. However, a configuration may also be adopted in which the sample interpolation process P₂ is executed once to determine two interpolation values at one time.

According to the above described embodiment, an error with respect to a true value can be reduced to a minimum with simple processing.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A digital audio signal interpolation apparatus configured to interpolate an uncorrectable point in a digital audio signal extracted from a CD or the like;
wherein the apparatus is configured to select an interpolation value candidate region of the uncorrectable point, to equally divide the interpolation value candidate region into a plurality of divided regions, to cause representative values of the divided regions to be added to and passed through a high-pass filter, the high-pass filter configured to reproduce a state up to a point immediately preceding the uncorrectable point, to select one of the divided regions comprising a lowest value, further to divide the selected region equally into a plurality of divided small regions, to cause representative values of the divided small regions to be added to and passed through the high-pass filter, and to take the representative value of one of the divided small regions comprising a lowest value as an interpolation value of the uncorrectable point.

2. The digital audio signal interpolation apparatus of claim 1, wherein the digital audio signal interpolation apparatus is configured to calculate interpolation values of a plurality of the uncorrectable points by gradually narrowing down regions comprising a lowest value, when the uncorrectable points are added to and passed through the high-pass filter configured to reproduce a state up to the point immediately preceding the uncorrectable points, if the uncorrectable points occur in series.

3. The digital audio signal interpolation apparatus of claim 2, wherein the digital audio signal interpolation apparatus is configured to calculate a non-constant rate of increase and decrease using values of three points that have been interpolated by the narrowing down, and to calculate an interpolation value of a fourth and subsequent uncorrectable point based on the rate of increase and decrease, if four or more of the uncorrectable points occur in series.

4. The digital audio signal interpolation apparatus of claim 1, wherein a number of the divided regions generated by equally dividing the interpolation value candidate region is equal to a number of the divided small regions generated by equally dividing the divided region.

5. The digital audio signal interpolation apparatus of claim 1, wherein a number of the divided regions generated by equally dividing the interpolation value candidate region is four.

6. The digital audio signal interpolation apparatus of claim 5, wherein a number of the divided small regions generated by equally dividing the divided region is four.

7. A digital audio signal interpolation apparatus configured to interpolate an uncorrectable point in a digital audio signal extracted from a CD or the like;
wherein the apparatus is configured to select respective interpolation value candidate regions of two of the uncorrectable points in series, to equally divide the interpolation value candidate regions into a plurality of divided regions, to cause representative values of the divided regions of a first uncorrectable point of the two uncorrectable point and representative values of the divided regions of a second uncorrectable point of the two uncorrectable point to be added to and passed through a high-pass filter, the high-pass filter configured to reproduce a state up to a point immediately preceding the uncorrectable points, to select a combination of ones of the divided regions comprising lowest values, to equally divide each of the selected divided regions into a plurality of divided small regions, to cause representative values of the divided small regions of the first uncorrectable point, representative values of the divided small regions of the second uncorrectable point, and a value of the immediately preceding point to be added to and passed through the high-pass filter, and to take the representative values of a combination of ones of the divided small regions comprising lowest values as interpolation values of the uncorrectable points.

8. The digital audio signal interpolation apparatus of claim 7, wherein a number of the divided regions generated by equally dividing an interpolation value candidate region of one of the uncorrectable points is equal to a number of the divided regions generated by equally dividing an interpolation value candidate region of a third uncorrectable point out of the uncorrectable points.

9. The digital audio signal interpolation apparatus of claim 7, wherein a number of the divided regions generated by equally dividing the interpolation value candidate region is equal to a number of the divided small regions generated by equally dividing the divided region.

10. The digital audio signal interpolation apparatus of claim 7, wherein a number of the divided regions generated by equally dividing the interpolation value candidate region is four.

11. The digital audio signal interpolation apparatus of claim 10, wherein a number of the divided small regions generated by equally dividing the divided region is four.

12. A digital audio signal interpolation method, comprising:
selecting an interpolation value candidate region of an uncorrectable point in a digital audio signal from a CD or the like;
equally dividing the interpolation value candidate region into a plurality of divided regions;
causing representative values of the divided regions to be added to and passed through a high-pass filter configured to reproduce a state up to a point immediately preceding the uncorrectable point in order to selecting one of the divided regions comprising a lowest value;
equally dividing the selected divided region into a plurality of divided small regions; and
causing representative values of the divided small regions to be added to and passed through the high-pass filter, and taking the representative value of one of the divided small regions comprising a lowest value as an interpolation value of an uncorrectable point.

13. The digital audio signal interpolation method of claim 12, further comprising:
calculating interpolation values of a plurality of the uncorrectable points in series by gradually narrowing down regions comprising a lowest value when the uncorrectable points are added to and passed through the high-pass filter, if the uncorrectable points occur in series.

14. The digital audio signal interpolation method of claim 13, further comprising:
calculating a non-constant rate of increase and decrease using values of three points that have been interpolated by the narrowing down if four or more of the uncorrectable points occur in series; and
calculating an interpolation value of a fourth and subsequent uncorrectable point based on the rate of increase and decrease.

15. The digital audio signal interpolation method of claim 12, wherein a number of the divided regions generated by equally dividing the interpolation value candidate region is equal to a number of the divided small regions generated by equally dividing the divided region.

16. The digital audio signal interpolation method of claim 12, wherein a number of the divided regions generated by equally dividing the interpolation value candidate region is four.

17. The digital audio signal interpolation method of claim 16, wherein a number of the divided small regions generated by equally dividing the divided region is four.

18. The digital audio signal interpolation method of claim 12, further comprising:
selecting an interpolation value candidate region for each of the points, if two of the uncorrectable points occur in series;
equally dividing the interpolation value candidate regions into a plurality of divided regions;
causing representative values of the divided regions of a first uncorrectable point of the two uncorrectable points and representative values of the divided regions of a second uncorrectable point of the two uncorrectable points to be added to and passed through the high-pass filter;
selecting a combination of ones of the divided regions comprising lowest values;
equally dividing each of the selected divided regions into a plurality of divided small regions;
causing representative values of the divided small regions of the first uncorrectable point, representative values of the divided small regions of the second uncorrectable point, and a value of the immediately preceding point to be added to and passed through the high-pass filter; and
taking the representative values of a combination of ones of the divided small regions comprising lowest values as interpolation values of the uncorrectable points.

19. The digital audio signal interpolation method of claim 18, wherein a number of the divided regions generated by equally dividing an interpolation value candidate region of the first uncorrectable point is equal to a number of the divided regions generated by equally dividing an interpolation value candidate region of the second uncorrectable point.

20. The digital audio signal interpolation method of claim 18, wherein a number of the divided regions generated by equally dividing the interpolation value candidate region is equal to a number of the divided small regions generated by equally dividing the divided region.
